(19) United States
(12) Patent Application Publication
(10) Pub. No.: US 2002/0087384 A1
(43) Pub. Date: Jul. 4, 2002

(54) Cross-retail store individualized price differential network system and method

(76) Inventor: Richard A. Neifeld, Arlington, VA (US)

Correspondence Address: NEIFELD IP LAW, PC, CRYSTAL PLAZA 1, SUITE 1001, 2001 JEFFERSON DAVIS HIGHWAY, ARLINGTON, VA, 22202, US

(21) Appl. No.: 09/750,709

(22) Filed: Jan. 2, 2001

(51) Int. Cl. G06F 17/60

(52) U.S. Cl. 705/10; 705/14

(57) ABSTRACT

The invention provides a computer network system and a method of using the system to influence consumer retail store shopping behavior by offering a consumer an incentive to shop at first retail store if data analysis indicates that the consumer is likely to shop at a store competing for the consumer's business. The invention also provides means for determining the value and conditions imposed upon the consumer receiving the incentive offered based upon data indicating the differential value to the consumer in shopping at the competing retail store instead of the first retail store and data indicating the value to the first retail store of the consumer's anticipated purchase, if that purchase is made from the first retail store.

### FIELD OF THE INVENTION

This invention relates to the field of consumer marketing using the Internet.

### DISCUSSION OF THE BACKGROUND

Incentives for a discount upon purchase of a product in a retail store are offered over the Internet. One form of incentive offer over the Internet is data defining a printable bar code such that, when the subsequently printed bar code is scanned at the point of sale printer in a supermarket in association with product items in a customer's order, and that purchase at that supermarket was a condition of satisfying the incentive offer, the customer receives a credit voucher against the customer's next purchase. The value of the voucher may equal the sum of the value of all of the discounts available for product items in the customer's order. See www.supermarketsonline.com. Such a system is described in U.S. Pat. No. 5,970,469 to Srcoggie et al. In the foregoing system, the consumer may select the supermarket that must be shopped at as a condition of receiving the incentive defined in the incentive offer.

### SUMMARY OF THE INVENTION

The invention is directed towards influencing the consumer's selection at which of competing retail stores to shop. The competing retail stores are retail stores that potentially compete for the consumer's business for certain products. These competing stores have in common that they must be accessible to the consumer (either via the Internet or geographically close enough to the consumer's location that there is a reasonable chance the consumer with shop those stores) and sell the same generic types of products as one another. Examples of generic products are groceries, household items, clothing for men, clothing for women, gasoline and related fuel products, prescription and over the counter drugs and related health aids, convenience items, automobiles, prepared meals. Supermarkets are competing stores. Department stores are competing stores. Mens clothing stores are competing stores. Gasoline stations are competing stores. Pharmacy stores are competing stores. Convenience stores are competing stores. Car sales stores are competing stores. Restaurants are competing stores.

The applicant realized that consumer provided information could be beneficially used to the advantage of a first retail store to influence a consumer intending to products and/or services provided by the first retail store from the first retail store, if the consumer provided information indicated that the consumer intended to purchase those products and/or services at a competing second retail store, by providing the consumer an incentive to shop at and/or purchase from the first retail store.

The applicant realized that the value to a retailer of a purchase by a consumer from the retailer of multiple product items is relatively high compared to the purchase from the retailer of a single item. The applicant realized that a first retail store would pay a relatively large sum of money to incent a customer intending to make a valuable purchase, such as a purchase of multiple items from a second retail store, to instead make that purchase from the first retail store.

The applicant realized that current purchase incentive distribution systems do not capitalize on this fact by incenting a consumer to purchase at the first retail store instead of the second retail store. The current purchase incentive distribution systems do not use knowledge of the value to the first retail store of the consumer's anticipated purchase at the second retail store in deciding whether and how to incent the customer to purchase at the first retail store. Moreover, the current purchase incentive distribution systems do not use knowledge of the difference in cost to the consumer to shop at different retail stores in deciding how to incent the consumer to shop at a first retail store instead of the second retail store. As discussed below, the present invention provides a means for capitalizing on these realizations.

Accordingly, one object of the invention is to capitalize on the value to a first retail store of driving sales to that first retail that otherwise would not be obtained by a competing second retail store, by using knowledge regarding where the consumer intends to purchase. The first and second retail store may be either brick and mortar retail stores or an Internet based (Web site) retail store (defined as an “etail” store or an “etailer”). Both brick and mortar and etailer retail stores are referred to herein below as retail stores unless clearly specified otherwise.

Another object of the invention is to capitalize on the value to a first retail store of having consumers' purchase at that first retail store (1) by determining whether to offer an incentive to the consumer to purchase at the first retail store, (2) by determining what value of incentive to offer to the consumer to shop at the first retail store, and (3) by determining what conditions that the consumer must fulfill to get the incentive, and (4) to make those determinations based upon knowledge including information on the consumer's intended purchase and prior purchases indicating (a) where the consumer intends to purchase, (b) what the consumer intends to purchase, and (c) how much money the consumer intends to spend in an upcoming purchase.

Another specific object of the invention is to provide a consumer an incentive to purchase from a first retail store (or any retail store of one retail chain) only if the consumer indicates an intent to purchase at a competing retail store.

Another object of the invention is determine a value of an incentive to offer to a consumer to incent the consumer to shop or purchase at the first retail store wherein the value of the incentive offered is based at least in part upon an estimate of the relative cost to each specific consumer (in any or all of time, money, and store preferences) in purchasing at the first retail store instead of a competing second retail store.

Another object of the invention is to determine a value of an incentive to offer to a consumer to incent the consumer to shop or purchase at the first retail store wherein the value of the incentive is based at least in part upon an estimate of the value that would be received by the first retail store in obtaining the consumer's anticipated purchase.

Another object of the invention is to determine a value of an incentive to offer to a consumer to incent the consumer to shop or purchase at the first retail store based at least in part upon a combination of (1) the relative cost to the consumer of shopping at the first retail store instead of a competing second retail store and (2) the value to the first retail store in capturing the consumer's anticipated purchase.

Another object of the invention is to provide a network implemented system and method for providing consumers incentives to shop at a first retail store based at least in part upon one of (1) an indication that a consumer does not intend to shop at the first store, (2) an estimate of the relative cost to that specific consumer in purchasing at the first retail store instead of at a competing second retail store, and (3) an estimate of the relative value to the first retail store of the anticipated purchase by that specific consumer.

Another object of the invention is to provide a first retail store a method for marketing their goods and services to consumers by determining whether and what types of incentives to offer each specific consumer, depending at least in part upon at least one of (1) information relating to the relative cost to the consumer in shopping at the first retail store compared to a competing retail store, (2) the value to the first retail store in obtaining the each specific consumer's anticipated purchase, and (3) information provided by each specific consumer on which retail store the consumer intends to purchase and what each consumer intends to purchase, and (4) information regarding what each specific consumer has previously purchased, and (5) information regarding what incentive offers the consumer has previously selected, and (6) information regarding what incentive offers the consumer has previously accepted.

These and other objects are provided by a computer network system and a method of using the system, wherein the system comprises a consumer's computer, an incentive server computer, a database of information accessible to the incentive server computer, a means, such as the Internet or dial up connections, through which the consumer's computer and the incentive server computer can exchange data. Using that system, (1) the consumer may provide via the consumer's computer information to the incentive server computer regarding the consumer, such as where the consumer intends to shop and what the consumer intends to purchase and (2) the incentive server computer may offer to the consumer via the consumer's computer an incentive to purchase or shop at a first retail store (or at any retail store of a first chain of retail stores). Preferably, the system also includes communication links between the incentive server computer and the retail store computers so that the incentive server computer can communicate information to and from retail store computers so that information regarding consumer transactions at point of sale (POS) terminals in the retail stores can be communicated to the incentive server computer. The retail store computers are computers that have access to information received at the POS terminals in retail stores. The retail store computers may perform POS terminal control, or may be in communication with the same data storage units used to store information used by the POS terminals and information used by a POS controller. The information used by the POS controller may include product identification codes, such as universal product codes (UPCs), prices for each identified item, and stock availabilities of product items.

Means are provided to determine whether to offer an incentive to the consumer and to determine what incentive to offer to the consumer, and these means may be part of the incentive server computer or may be associated with another computer that can communicate with the incentive server computer.

The invention provides a computer network system and a method of using the system to influence consumer retail store shopping behavior by offering a consumer an incentive to shop at first retail store if data analysis indicates that the consumer is likely to shop at a store competing for the consumer's business. The invention also provides means for determining the value and conditions imposed upon the consumer receiving the incentive offered based upon data indicating the differential value to the consumer in shopping at the competing retail store instead of the first retail store and data indicating the value to the first retail store of the consumer's anticipated purchase, if that purchase is made from the first retail store.

### BRIEF DESCRIPTION OF THE DRAWINGS

FIG. 1 is a schematic showing a computer network system including an incentive server computer and a client computer; and

FIG. 2 is a flowchart showing steps that occur during operation of the network shown in FIG. 1.

### DESCRIPTION OF THE PREFERRED EMBODIMENTS

Other aspects and advantages of the invention as well as specific embodiments and specific types of data used to determine whether and what type of incentive to award to the customer will become apparent from the more detailed description that follows, taken in conjunction with the drawings, which are briefly described below. Referring now to the drawings, like reference numerals refer to identical or corresponding elements:

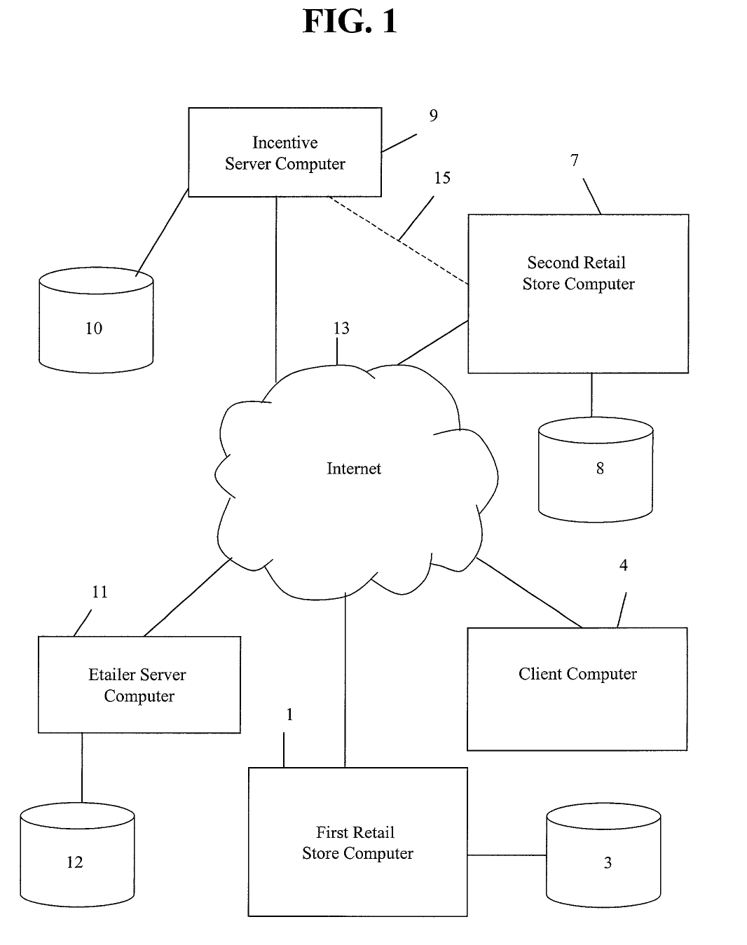

FIG. 1 shows a computer network system comprising a first retail store computer 1 that can communicate with a first retail store database 3. The first retail store computer 1 is associated with a first retail store, and is associated with point of sale terminals of the first retail store at which consumers can purchase goods from the first retail store. The POS terminals may conventional POS system terminals located inside a brick and mortar store, or may be a consumer's client computer 4 located at a consumer's home, business, or travel location if purchases are made by the consumer over the Internet. First retail store computer 1 may be connected to the Internet 13.

Client computer 4 may be connected to the Internet 13. Use of client computer 4 is typically associated with a certain consumer or family of consumers.

Second retail store computer 7 interacts with second retail store database 8 and may be connected to the Internet 13. Second retail store computer 7 is associated with a second retail store, and is associated with POS terminals at which consumers can purchase goods from the second retail store.

Incentive server computer 9 interacts with database 10 and is connected to Internet 14.

An etailer is a retail store selling via the Internet products and/or services, which a consumer purchases by interacting in with a pre programmed etailer's server computer. Etailer server computer 11 of an etailer interacts with etailer server database 15 and is connected to the Internet 13.

The first and second retail store computers 1, 7, and the etailer server computer 11 may have dial up communication connections to the incentive server computer, such as the dial up direct connection 15.

The client computer 4 may be a conventional desktop personal computer, but it may also be a set top box connected to a TV, it may receive instructions either through wire connections or wireless connection, and it may be a personal digital assistant, portable computer, and it may have a wire or wireless connection to the Internet or a dial up line.

The retail store computers 1, 7, may be located in the respective retail store locations or may be located remote from their respective retail stores. In addition, each retail store computer 1, 7, may be in communication with a plurality of retail stores in a retail store chain. The retail store server may be the control computer for a point of sale system for a retail store or a chain of retail stores. Incentive server computer 9 runs web server software so it can respond to instructions from client computers such as client computer 4, received via transmission through the Internet 13.

The consumer uses the client computer 4 and its software, such as a web browser or a dial up connection software, to transmit and receive data over the Internet (e.g., a web browser program for receiving and displaying graphical file information on the client computer's display monitor device) and specifically to send and receive data from the incentive server computer 9.

In the following discussion, reference to the consumer sending and receiving information means that the information is being sent and received by the client computer 4 directed to and received from the incentive server computer 9.

Data Received From Consumer's Client Computer 4

The decision whether to provide to the consumer an incentive to purchase at a certain retail store is preferably based upon at least one of (1) information contained in data transmitted from the consumer's client computer 4 and received by the incentive server computer 9 during a communication session between client computer 4 and the incentive server computer 9 and (2) information contained in data already stored in the incentive server computer database 10 prior to the communication session.

While data transmission over the Internet is considered to be stateless, state and session have well known meanings when referring to a client computer's interactions with a web site, due either to the use of so called session variables, cookies, or a logical progression through links intended to be traversed in a particular order. Hence, a session, which relates to state, also has a well defined meaning and relates to a consumer's use of a web site for a specified purpose. Session management variable values indicate when a session has ended, may indicate an identification of the source of signals received by the incentive server computer 9 for that session. In addition, a session relates to a consumer's client computer's logical progression of requesting web pages from an incentive server computer's web site. Sessions typically do not last more than one hour.

The data received from the consumer may include consumer identification data identifying the consumer, such as a name, number, alphanumeric identifier, email address, social security number, frequent shopper card identification, retinal scan pattern, fingerprint scan pattern, other biometric pattern, bank account number, credit card number, personal Internet address, residence address, postal address, etc.

The data received from the consumer may also include consumer retail store preference data, such as data indicating which retail stores the consumer has purchased from in the past, which retail stores the consumer likes, which retail stores the consumer dislikes, which retail store the consumer does intend to purchase from in a future purchase, and which retail store the consumer does not intend to purchase from in a future purchase.

The consumer retail store preference data received from the consumer may also include consumer frequent shopper membership data identifying retail stores in which the consumer has a frequent shopper program membership. A frequent shopper program is any program in which the consumer obtains discounts in response to providing a frequent shopper account identification, preferably but not necessarily during a purchase transaction and preferably but not necessarily at checkout at a POS terminal.

The consumer retail store preference data may also include consumer differential money amount data that indicates what amount of money the consumer would accept to purchase from a first retail store compared to competing second retail store, in other words, the consumer's subjective differential cost associated with purchasing at the first retail store relative to the competing second retail store.

The data received from the consumer may also include consumer location data indicating the geographic location of the consumer (or the consumer's computer), such as Global Position System coordinate, map coordinate, street cross-section, street, city, region, state, and postal code data.

The data received from the consumer may also include the consumer purchase value data indicating the money value or range of value for the consumer's future purchase, for example, the dollar value the consumer future to purchase, the money value or money value range of the consumer's future goods purchase transaction. Preferably, this data is for the consumer's next intended transaction purchasing goods and services of the type sold by the first retail store. The first retail store may sell one or more of groceries, convenience items, fuel products, meals, etc.

The data from the consumer may also include consumer product selection data, such as a list of product items selected by the consumer. The items identified in the consumer product selection data may be in response to a query from the incentive server computer regarding what products the consumer wants to purchase, regarding what incentive offers (for incentives requiring purchase of specified products) the consumer wants to receive, regarding what products for which the consumer wants to receive information, and any other query to which the consumer responds with product identifications.

The data from the consumer may also include consumer generic food type selection data, which is data that specifies a food type and optionally food quantity, but which does not specify brand or product item. For example, the consumer could specify a quantity of paper plates, instead of a brand item name for paper plates, or the consumer could specify a five pound bag of sugar instead of specific brands and product items for a five pound bag of sugar.

The data from the consumer may also include consumer recipe selection data, which contains at least one specified recipe. Each recipe is defined as requiring either generic types of foods necessary to prepare a dish and/or specific brand products necessary to prepare the dish.

In addition, the data sent from the client computer 4 includes client computer transmission format data, which indicates in what format the incentive server computer 9 should transmit data to the client computer 4, such as standard HTML W3C version 4.0 or in a WAP format. WAP format is suitable for portable computing devices that use wireless communication. The incentive server computer can determine based upon the query received from the consumer's client computer for a web page, whether the incentive server computer is requesting WAP formatted transmission instead of a conventional HTML standard transmission and store this information in the database in association with the identification of the consumer. Other data formats may be particularly suited to wireless communication, and the format of data requested by the client computer 4 may indicate whether the client computer 4 was using a wireless communication device in a prior session or is using a wireless communication device in a current session.

Data Stored in the Database

The data stored in the incentive server database 10, to which the incentive server computer 9 has access, preferably contains information associated with the consumer, information associated with retail stores, information associated with products items, information associated with manufacture incentive offers, that is, offers for incentives for which a manufacturer has agreed to pay, information associated with retail store provided incentive offers, information associated with which product items are available in specified retail stores, and information associated with algorithms used to determine retail store provided incentive offers, and information associated with retail store levels and overstock conditions.

The data regarding the consumer already stored in the incentive server computer database 10 may include data received from the consumer in prior communication sessions between the consumer's computer and the incentive server computer, including but not limited to identification of the consumer, and in association therewith consumer retail store preference data, consumer location data, consumer purchase value data, consumer product and generic food selection data, and consumer recipe data. This data regarding the consumer may have been provided to the incentive server computer by the consumer in a prior communication. The prior communication in this context refers to a time period during a prior session between the consumer's client computer and the incentive server computer in which the consumer had selected at least one product item.

The data stored in the incentive server computer database 10 preferably also contains prior purchase data containing, associated with the identification of each consumer, identification of product items the consumer previously purchased, the charges for those items, the money value of the consumer's prior purchases, and when the prior purchases occurred, the retail store name in which prior purchases were made, and retail chain name of that store, which data is collectively referred to herein as prior purchase data or purchase history data.

In addition, data stored in the incentive server computer database 10 preferably also contains information derived from prior purchase data, such as the frequency of the consumer's prior purchases, frequency of the consumer's prior purchase of specified products, which product items the consumer has purchased more frequently than other product items (i.e., the relative frequency of purchase by each consumer of items the consumer has purchased), the consumer's tendency to purchase on a given day of the week and a given time of day, whether a consumer tends to purchase at various retail stores, and whether and what type of incentives previously offered to the consumer have been redeemed. From the dates of the prior purchase data, a computer or a human can determine the frequency of the consumer's prior purchases, whether the consumer tends to purchase on a given day of the week, a given time of day, whether a consumer tends to purchase at various retail stores, and whether and what type of incentives previously offered to the consumer have been redeemed, whether the consumer tends to make relatively large money amount purchases when redeeming incentives.

The data stored in the incentive server computer database 10 preferably also contains data indicating whether the consumer's prior communications with the incentive server computer 9 were via web pages in conventional format, such as W3C HTML version 4.0 format, or in a format suitable for wireless communications, such as WAP format.

The data stored in the incentive server computer database 10 preferably also contains information associated with retail stores, including the locations of retail stores, prices for product items charged by each of those retail stores, a measure of differences in prices charged by those retail stores, and which retail stores are competing retail stores with one another. The measure of difference in price could be the price of an average market basket. Alternatively, the measure may be individualized for each consumer based upon the costs in each store of purchasing at least some of the product items contained in the consumer's prior purchase data.

The data stored in the incentive server computer database 10 associated with each retail store preferably also includes data identifying the product items that the retail store stocks, the prices charged for each item, the location of the retail store, and the frequent shopper program discounts that each retail store employs.

The data stored in the incentive server computer database 10 associated each retail store preferably also includes in association with the retail store data indicating which products that retail store stocks for which a manufacturer's incentives are available.

A manufacturer's incentive means an incentive paid ultimately by the manufacturer conditioned on the consumer's purchase of a product item. The incentives may for example be provided by the manufacturer contingent upon purchase of a product made by that manufacturer in order to promote sales of that manufacturer's products. The information on availability at various retail stores of a product for which a manufacturer's incentive is available relates to the relative cost to the consumer to purchase at different stores, since it is less expensive for the consumer to purchase a product item and obtain a discount on the product item from a store where that product item is sold than to alternatively purchase a competing product item a competing store where the discounted product item is not sold.

Incentive Algorithms Using Data

The incentive server computer or another computer executes an incentive offer determination algorithm to determine whether to provide any incentive offer to a consumer and what terms to include in the incentive offer.

The incentive offer determination algorithm may be executed during a session of the consumer's client computer 4 with the incentive server computer 9 or the incentive offer determination may be made between those sessions. If the determination is made between those sessions, the determination is made based upon certain data stored in the incentive server computer database 10 relating to the consumer and the retail stores at which the consumer is likely to purchase.

The decision whether to offer an incentive to the consumer is preferably based upon at least one of (1) whether the consumer has previously purchased from the first retail store or a second competing retail store, (2) whether the consumer has indicated an intent to purchase from the first retail store or at a competing second retail store, (3) the dollar value of the consumer's prior purchases, (4) the dollar value of the consumer's selected items, and (5) whether the consumer is using a wireless device protocol to communicate with the incentive server computer 9.

A substantial factor in the determination whether to offer an incentive to the consumer for the consumer to shop at the first retail store is whether information indicates the consumer intends to shop at a competing retail store in an upcoming purchase. Hence, if the information received from the consumer by the incentive server computer 9 and the information stored in the incentive server computer database 10 indicates that the consumer is not likely to shop at the first retail store in an upcoming purchase, then the incentive offer determination algorithm decides to offer the consumer an incentive to shop at the first retail store for the upcoming purchase.

Alternatively, the incentive offered to the consumer may depend upon the information indicating whether the consumer is likely, and how likely, to shop at the first retail store.

Conversely, if the information received from the consumer by the incentive server computer 9 and the information stored in the incentive server computer database 10 indicates that the consumer is likely to shop at the first retail store in an upcoming purchase, then the incentive offer determination algorithm may decide not to offer an incentive to the consumer to shop at the first store, may decide to offer an incentive of lesser value to the consumer to shop at the first retail store, may decide to offer an incentive to the consumer intended to promote sale of products not previously purchased by the consumer from the first retail store, may decide to offer an incentive to the consumer intended to promote sale of products not previously sold at the first retail, or may decide to offer only manufacturer's incentives to the consumer.

One indication that a consumer intends to shop at the first retail store is the consumer's selection of coupons available at the first retail store. Another indication is that the consumer's client computer is using a wireless protocol, such as WAP, and selects the first retail store, indicating that the consumer may actually be in the first retail store during the session, and therefore is highly likely to shop at the first retail store no matter what incentive is offered.

If the consumer's client computer is using a wireless protocol, such as WAP, and selects a retail store competing with the first retail store, indicating that the consumer may actually be in the second retail store during the session, and therefore is highly likely to shop at the second retail store, the incentive server computer may offer a relatively valuable incentive for the consumer to shop at the first retail store, and the relatively valuable incentive may have a short term expiration, such as the same hour or same day during which it must be accepted, in order to incent the consumer to go from the competing retail store to the first retail store.

An incentive selection determination algorithm may preferably be implemented by a programmed computer, but may also be performed by a human, or partially implemented by both a computer and a human using computer based tools, such as database queries and update operations, to determine what incentive to offer to the consumer. The programmed computer may be the incentive server computer 9, one of the retail store computers 1, 7, 11, or another computer in communication with the incentive server computer 9.

The incentive selection determination algorithm preferably includes steps leading to a determination of what incentive to offer the consumer to purchase at the first retail store. The incentive selection determination algorithm can be performed during or between the consumer's client computer 9's sessions with the incentive server computer 9.

An incentive value determination algorithm may preferably be used to determine what value of an incentive to offer the consumer, preferably based upon at least one of (1) the dollar value of the consumer's prior purchases, (2) the dollar value of the consumer's selected items, and (3) the value to the retail store of each one of the consumer's prior purchases, and (4) the value to the retail store of a purchase of the consumer's selected items. The incentive value determination algorithm may preferably be used by a computer, but may also be performed by a human, or partially implemented by both a computer and a human using computer based tools, such as database queries and update operations, to determine value to assign to an incentive. The incentive value determination algorithm can be performed during or between the consumer's client computer 4's session with the incentive server computer 9.

Preferably, the incentive value determination algorithm limits the value of the incentive offered to less than the value to the first retail store in selling to the consumer the consumer's anticipated purchases. In this regard, the incentive value determination algorithm may simply be a flat fraction of the anticipated dollar value of the consumer's anticipated purchase, such as one, three, five, or ten percent of the consumer's anticipated purchase. The anticipated dollar value is the sale price of the sum of the products that the consumer is anticipated to buy, for example based upon the average dollar value of the consumer's prior purchases or the dollar value of the products identified in the consumer's product selection data.

If the consumer's client computer is using a wireless protocol, such as WAP, and selects a retail store competing with the first retail store, indicating that the consumer may actually be in the second retail store during the session, and therefore is highly likely to shop at the second retail store, the incentive server computer may offer a relatively valuable incentive for the consumer to shop at the first retail store, and the relatively valuable incentive may have a short term expiration, such as the same hour or same day during which it must be accepted, in order to incent the consumer to go from the competing retail store to the first retail store and purchase from the first retail store.

Preferably, the value to the first retail store of the consumer's anticipated purchase is estimated based upon knowledge of the profit margin to the first retail store of for purchase of the specific product items or categories of products that the consumer is likely to purchase, as indicated for example by the consumer's prior purchase history and/or product selection data. For example, the profit to the first retail store in selling ten dollars of baked goods may be one dollar, whereas the profit to the store in selling ten dollars of canned goods may be one tenth of a dollar. The consumer's prior purchase history may show an average purchase of fifty dollars, indicating that the consumer is likely to purchase in the next transaction about fifty dollars. These factors may be included in determining the value of the incentive to offer to the consumer so that for example the value of the incentive offered does not exceed the anticipated profit the first retail store will make in obtaining the consumer's purchase.

The value to the first retail store may be a function of the relative dollar value of the consumer's anticipated purchase, and may for example be a fraction of the sales price which fraction increases with the dollar value of the sale. For example, the profit to the first retail store of the consumer purchasing one hundred dollars of specified goods may be ten dollars, a ten percent profit margin, whereas the profit to the first retail store of the consumer purchasing ten dollars may be negligible, due to overhead and transaction cost factors, which amounts to a zero percent profit margin.

Both the value and the conditions of the incentive offers provided by the incentive server computer (1) may be selected from a list of (one or more) such incentives stored in the database or (2) may be derived based upon information received by the consumer and information stored in the database and a set of incentive selection algorithms.

The incentive may be conditioned on the consumer purchasing either at a specified retail store or at one of a specified set of retail stores.

The incentive offer may be a discount conditioned on the consumer buying a specified product item, quantity of product items, product of a specified brand, or a group of products.

The incentive offer may be conditioned on the consumer's action in a limited time period, such with in one day, one week, or one month after the incentive is offered to the consumer.

The incentive offer may be conditioned on purchase of a product item that the consumer's prior purchase history stored in the database indicates the consumer is likely to purchase.

The incentive offer may be conditioned on purchase of a product that the consumer is likely to purchase for example as indicated by analysis the consumer's prior purchase history and for which the first retail store has a relatively high profit margin. For example, profit margins are typically higher on delicatessen items that canned goods, and therefore the first retail store could offer a larger discount contingent upon the purchase of a delicatessen item, such as potato salad, than a comparably priced canned good, such as canned green beans, and still realize a profit on the sale of the delicatessen item.

The incentive offer may be conditioned on purchase of a product item that the consumer's prior purchase history stored in the database indicates the consumer is not likely to purchase and which has a relatively high profit margin for the first retail store.

The incentive offer may be a discount on any purchase, or a discount on any purchase over a specified money value. The value of the incentive offer can depend upon the dollar value of the consumer's prior or subsequent purchase.

The incentive offer may be an offer to receive a free item or prize solely upon the condition that the consumer visit the location of the first retail store. That is, the incentive offered may not be contingent upon the consumer purchasing at the first retail store. Alternatively, the incentive offered may be contingent only upon the consumer making a purchase at the specified first retail store (or a store in the same retail chain), that is, not contingent upon what the consumer purchases.

Example of the invention follow.

### EXAMPLE 1

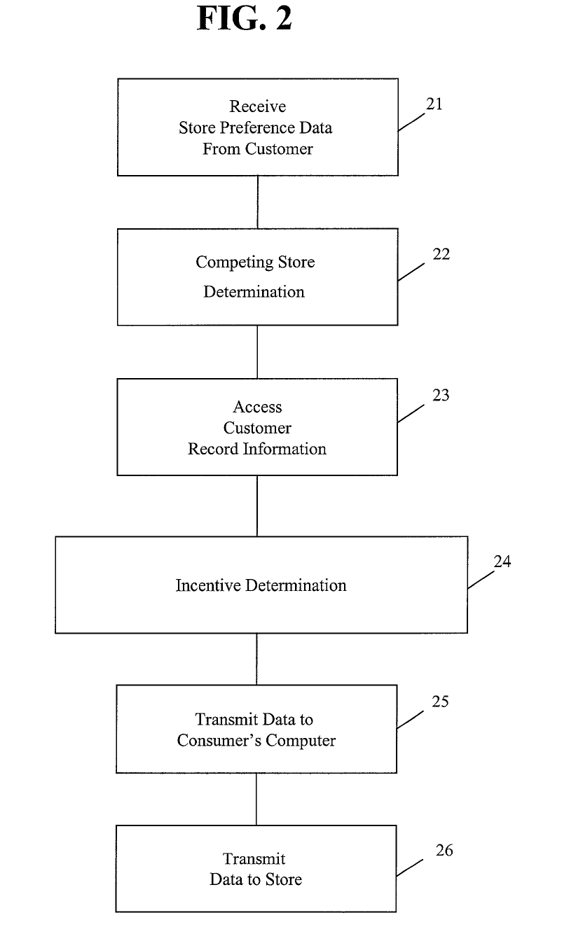

As shown in FIG. 2, optionally in step 21, the consumer sends the computer 9 consumer retail store preference data.

In step 22, the system determines whether the consumer is likely to shop at the first retail store or a competing second retail store.

Optionally in step 23, the system accesses the consumer's record from the incentive server computer database 10. This presupposes that the client computer sent consumer identity data to the incentive server computer in step 21 so that the incentive server computer can identify the consumer's record.

In step 24, the system determines what incentive to offer to the consumer.

In step 26, the incentive server computer 9 (or another computer) transmits the data indicating the incentive offer to the client computer 4.

Optionally in step 27, the incentive server computer (or another computer) transmits data relating to the incentive offer, such as the existence of the offer, the identity of the consumer to which it was offered, and the terms of the offer, to the first retail store computer, allowing the first retail store computer to track offers and redemptions of offers.

The only steps required for example 1 are the receipt by the incentive server computer 9 of consumer retail store preference data in association with a consumer identification, the incentive determination by the system based upon the consumer's consumer retail store preference data, and the transmission of an incentive offer to the consumer. The consumer retail store preference data need not be during a communication session, for example, based solely upon prior purchase history. The transmission of the incentive to the consumer may be via an email message to the consumer's email address. The incentive determination may be made running the incentive determination algorithms on a computer other than the incentive server computer 9, such as any computer that can communicate with the incentive server computer database 10.

### EXAMPLE 2

In step 21, the computer 9 receives consumer retail store preference data indicating the consumer intends to shop in the second retail store.

In step 22, the computer 9 determines if the first retail store is a store that competes with the second retail store. This may include computer 9 determining if the first retail store is relatively close to the second retail store by accessing data in database 10 (or elsewhere so long as the data is available to computer 9) relating to whether those two stores are competing stores, which may be a lookup table of competing stores for the first retail store, may include store location data, and may include product market data, in step 22. Relatively closeness may be determined by location in the same county, town, or postal code, or subdivision, as the second retail store. Relatively closeness may also be determined based upon absolute location data, such as GPS data, or based upon travel route data, routes determined automatically based upon location data and map data, such as the travel routes provided by www.mapquest.com, and travel times determine by the distance and type of roads between the consumer location and the first retail store location. Types of roads refers to highways versus local roads and the corresponding speed limits associated with each type of road, and number of stop signs and stop lights on those roads.

In steps 23 and 24, if the computer 9 determines that the first and second retail stores are competing stores and that the consumer intends to shop at the second retail store, the computer 9 generates an incentive offer incenting the customer to shop in the first retail store instead of the second retail store. In step 23, the computer 9 may access the customer record in the incentive server computer database 10 to include all of that data in determinations of the value and conditions of the incentive to offer to the customer, and then in step 24 use that information to determine the incentive value and conditions.

In step 25, the computer 9 transmits data defining the incentive offer to the consumer's client computer. The incentive offer typically contains data defining a bar code machine readable by the first retail store's POS terminal's bar code readers. However, other forms of encoding the incentive offer are possible, such as storage of the incentive offer on magnetic media or in RAM in a personal digital assistant (PDA) device, so long as it can be recognized by the first retail store's POS system. The data may be in the form of a self executable, a graphic file, a graphic in an HTML file (web page), or data storable on a PDA or cell phone and readable from those devices by a POS system, e.g., via infrared transmission.

Finally, the data defining the incentive offer may be transmitted to the first retail store computer 1 so that the first retail store computer ensure that all incentives offered to the first retail store are valid, in step 26.

The consumer then presents the incentive offer when shopping at the first retail store. If the first retail store is an etailer, the consumer may transmit the data defining the incentive offer to the etailer, or click a button on web page provided by the etailer that implements a program that automatically finds the incentive offer data on the consumer's computer and uploads it to the etailer's computer.

When the consumer shops at the first retail store and the first retail store is a brick and mortar store having POS terminal, preferably upon checkout, the consumer tenders the incentive offer. If all conditions of the incentive offer are fulfilled, such as purchases of specified items in the customer's order at checkout, a buying a specified dollar minimum, or simply tendering the incentive offer, the value identified in the incentive offer is provided to the consumer.

### EXAMPLE 3

The consumer sends the computer 9 identification data and location data.

The computer 9 has determined or now determines in response to receipt of the identification data if first retail store is located relatively close to the consumer's location. If the computer 9 has determined or now determines that the consumer is located relatively close to the first retail store, and the consumer retail store preference data indicates that the consumer is likely to purchase from another competing retail store, the computer 9 transmits to the consumer an incentive offer defining an incentive for the consumer to purchase from the first retail store.

### EXAMPLE 4

In step 21, the consumer sends the incentive server computer 9 consumer identification data, consumer retail store preference data indicating an intent to purchase from the second retail store, and product item selection data.

In step 24, the incentive server computer 9 determines an incentive available for the consumer to purchase items, preferably all of the items identified by the item selection data, from the second retail store. The incentive may include the value of manufacturer's discounts on several or all product items selected by the consumer. The incentive server computer determines an additional value to offer the consumer contingent upon the consumer purchasing at the first retail store.

In step 25, the incentive server computer 9 transmits to the consumer data defining an incentive offer combining the values of multiple manufacturer's discounts on product items selected by the consumer and the additional value of the offer contingent upon the consumer purchasing at the first retail store instead of the other retail store.

The additional value may be a function of the number of items selected, the value of the consumer's prior product purchase history, or the value of the items selected.

### EXAMPLE 5

Example 5 is the same as example 4, except that the incentive server computer 9 determines the additional value to be equal to or greater than a dollar amount of the money amount data, i.e., the consumer's indication of the money amount value to the consumer to shop at the second retail store instead of the first retail store.

### EXAMPLE 6

Example 6 is the same as example 4, except that the incentive server computer determines the additional value to be greater than an amount determined to be the differential cost to the consumer shopping at the second retail store instead of the first retail store based upon the differences in the distance or estimated travel times from the consumer's location to the location of the first retail store and the consumer's location to the location of the store at which the consumer indicates an intent to purchase.

### EXAMPLE 7

A consumer points the consumer's client computer 4's web browsing program to the universal resource locator (URL) for a web site hosted by the incentive server computer 9.

The server computer 9 sends the client computer 4 a home page web page containing a request for the consumer to provide consumer identification data (such as residence address, email address, telephone area code, postal code, name, and password), preferably by filling in a form contained in the web page, and to select a user name. The home page web page may also contain a form for the consumer to enter the consumer's user name and optionally also the consumer's password.

The consumer fills out the form on the home page web page, thereby providing consumer identification information to the server computer 9, and transmits the information in the form to the server computer 9.

The server computer 9 sends a web page file to the client computer 4 containing a form requesting the consumer to submit information for personalizing offers to that consumer, the form requesting for example demographic information including consumer income level, household income, anniversary dates, birth dates, number of homes owned, existence of a home office, existence of pets, educational level (e.g., completed high school, college, post college degree), occupation, number of automobiles owned, and categories of information the consumer is interested in, such as news letters, coupons, automotive, clothing, dining, groceries, home and garden, movies, dining, toys, babies, computers, investing, pets, sports, and travel.

In response, the incentive server computer 9 transmits a web page file to the client computer requesting the user to select a retail store or chain of retail stores for which discount offers for purchase of goods or services at the store may be available.

In response, the consumer's client computer transmits back to the server computer 9 data indicating a selection of a second retail store or second retail chain of stores.

In response, the server computer 9 transmits to the client computer a web page showing incentive offers available for selection at the consumer's selected second retail store. The incentive offers may include offers (1) from (i.e, ultimately paid for by) manufactures and (2) from (i.e., paid by) the second retail store.

In response, the client computer transmits to the server computer, incentive offer selection data, indicating which incentive offers that are available for selection for the second retail store the consumer wishes to be offered.

In response, the server computer 9 transmits to the client computer 4 data defining the incentives selected by the consumer.

In addition, the server computer 9 transmits to the client computer 4 data defining incentives for shopping the first retail store, if the first retail store is a competing with the second retail store for the consumer's business. The incentives for shopping the first retail store may include all of the manufacturer's incentives offered to the consumer for shopping the second retail store. In addition, the incentive offers include a first retail store incentive offer from the first retail store to incent the customer to shop the firs retail store. This first retail store incentive offer can take any of the forms discussed above, and provides a mechanism for the first retail store to obtain sales that would otherwise be obtained by a competing retail store. Alternatively, the incentives provided to the consumer to shop the first retail store may be emailed to the consumer's email address.

In summary, the invention provides consumers that are likely to shop at a store competing with the first retail store an incentive to shop at the first retail store so that the first retail store obtains the benefit of the consumer's sales. The invention is implemented using a computer network, preferably including the Internet. Preferably, there is an incentive server on the network that provides information to consumers, such as manufacturers discounts available on product purchases in competing stores so that the consumer's naturally provide a store selection to see what discounts they can get from the selected store, thereby enabling the first retail store an opportunity to target the consumers who are not planning to shop at the first retail store to receive an incentive to shop at the first retail store.

What I claim is:

1. A computer network implemented method comprising the steps of:
determining, from consumer retail store preference data associated with a consumer's consumer identification, a store selection determination, said store selection determination indicating whether said consumer is likely to shop at a second retail store competing with a first retail store or whether said consumer is likely to shop at said first retail store;
determining, based at least in part upon said store selection determination, a first retail store incentive determination, said first retail store incentive determination indicating whether to transmit to said consumer an incentive offer to incent said consumer to shop at said first retail store.

2. The method of claim 1 wherein, if said store selection determination indicates that said consumer is likely to shop at said second retail store, said first retail store incentive determination indicates transmitting to said consumer an incentive offer to incent said consumer to shop at said first retail store.

3. The method of claim 1 further comprising transmitting said incentive offer to a client computer associated with said consumer identification.

4. The method of claim 1 wherein said retail store preference data includes at least one of retail store name selection, consumer frequent shopper membership data, consumer differential money amount data, consumer location data, and purchase history data.

5. The method of claim 1 wherein said retail store preference data includes retail store name selection.

6. The method of claim 1 wherein said retail store preference data includes at least one of consumer differential money amount data and consumer location data.

7. The method of claim 1 wherein said store selection determination occurs during a communication session of a client computer and a server computer.

8. The method of claim 1 further comprising the step of transmitting from a client computer to a server computer data indicating said consumer identification a retail store name.

9. The method of claim 8 wherein said store selection determination is based at least in part upon said data transmitted from said client computer to said server computer.

10. The method of claim 9 wherein said store selection determination and said first retail store incentive determination occur during a communication session between said client computer and said server computer.

11. A computer network implemented method comprising the steps of:
determining, from consumer retail store preference data associated with a consumer identification, a store selection determination, said store selection determination indicating whether said consumer is likely to shop at a second retail store competing with a first retail store or whether said consumer is likely to shop at said first retail store;
depending terms of an incentive offer to incent said consumer to shop at said first retail store at least in part upon said store selection determination.

12. A computer network implemented method comprising the steps of:
determining a relative cost for a consumer to purchase from a first retail store instead of a second retail store;
depending a value of an incentive offer for said consumer at least in part upon said relative cost; and
transmitting an incentive offer for said consumer to shop at said first retail store to a client computer associated with a consumer identification for said consumer.

13. The method of claim 12 wherein said relative cost is determined based upon at least one of consumer frequent shopper membership data, consumer differential money amount data, consumer location data, retail store location data, and client computer transmission format data.

14. A computer network implemented method comprising the steps of:
determining a relative cost for a consumer to make an anticipated purchase from a first retail store instead of a second retail store;
determining a transaction value to said first retail store in obtaining said anticipated purchase;
depending an incentive value of an incentive offer for said consumer to shop at said first retail store at least in part upon said relative cost and said transaction value; and
transmitting an incentive offer having said incentive value for said consumer to shop at said first retail store to a client computer associated with a consumer identification for said consumer.

15. A method according to claim 14 wherein said transaction value depends upon at least one of a consumer product selection data, consumer generic food type selection data, consumer recipe selection data, and consumer purchase history data.

16. A computer network implemented method comprising the steps of:
determining, from client computer transmission format data and store name selection data associated with a consumer identification, a store selection determination for said consumer identification, said store selection determination indicating whether a consumer associated with said consumer identification is likely to shop at a second retail store competing with a first retail store or whether said consumer is likely to shop at said first retail store;
determining, based at least in part upon said store selection determination, a first retail store incentive determination, said first retail store incentive determination indicating whether to transmit to said consumer an incentive offer to incent said consumer to shop at said first retail store.

17. A computer network comprising:
means for determining, from consumer retail store preference data associated with a consumer's consumer identification, a store selection determination, said store selection determination indicating whether said consumer is likely to shop at a second retail store competing with a first retail store or whether said consumer is likely to shop at said first retail store;
means for determining, based at least in part upon said store selection determination, a first retail store incentive determination, said first retail store incentive determination indicating whether to transmit to said consumer an incentive offer to incent said consumer to shop at said first retail store.

18. A computer network comprising:
means for determining, from consumer retail store preference data associated with a consumer identification, a store selection determination, said store selection determination indicating whether said consumer is likely to shop at a second retail store competing with a first retail store or whether said consumer is likely to shop at said first retail store;
means for depending terms of an incentive offer to incent said consumer to shop at said first retail store based at least in part upon said store selection determination.

19. A computer network implemented comprising:
means for determining a relative cost for a consumer to purchase from a first retail store instead of a second retail store;
means for depending a value of an incentive offer for said consumer at least in part upon said relative cost; and
means for transmitting an incentive offer for said consumer to shop at said first retail store to a client computer associated with a consumer identification for said consumer.
